(19) United States
(12) Patent Application Publication
(10) Pub. No.: US 2005/0155503 A1
(43) Pub. Date: Jul. 21, 2005

(54) Sheet-fed offset rotary printing press

(76) Inventors: Kyotaro Onuma, Ibaraki (JP); Hiroyuki Sugiyama, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/039,504

(22) Filed: Jan. 19, 2005

(30) Foreign Application Priority Data
Jan. 20, 2004 (JP) 012245/2004

(51) Int. Cl. B41F 7/04

(52) U.S. Cl. 101/177

(57) ABSTRACT

A sheet-fed offset rotary printing press includes one plate cylinder, one blanket cylinder with the same size as that of the plate cylinder, one impression cylinder, one plate making device, four inking devices, four roller throw-on/throw-off devices, and a cylinder throw-on/throw-off device. At least one plate is mounted on an outer surface of the plate cylinder. The blanket cylinder opposes the plate cylinder, and at least one blanket is mounted its outer surface. The impression cylinder has at least one gripper device for holding a paper sheet. The plate making device can inscribe four printing patterns on four regions of the plate. The inking devices individually supply inks to the four printing patterns of the plate on the plate cylinder through four ink form rollers. The roller throw-on/throw-off devices throw on one ink form roller onto corresponding one printing pattern of the plate and throw off the remaining ink form rollers from the remaining printing patterns. The cylinder throw-on/throw-off device throws on the blanket cylinder supplied with the inks immediately before it opposes the paper sheet held by the gripper device, and throws it off before it opposes the impression cylinder while the gripper device does not hold a paper sheet.

### BACKGROUND OF THE INVENTION

The present invention relates to a sheet-fed offset rotary printing press suitable to perform multicolor printing on one paper sheet.

As shown in U.S. Pat. No. 6,050,188, a conventional sheet-fed offset rotary printing press has two double-size plate cylinders each having two printing surfaces, four inking units for supplying inks to the four printing surfaces of the two plate cylinders, two double-size blanket cylinders which are respectively in contact with the two plate cylinders and each of which has two printing surfaces, one triple-size impression cylinder with which the two blanket cylinders are in contact and which has three gripper devices to grip paper sheets, and two laser inscribing systems which respectively form images on the two plate cylinders.

With the conventional sheet-fed offset rotary printing press having the above arrangement, four-color printing is performed on three sheets gripped by the three gripper systems provided to one impression cylinders by using the total of four printing surfaces of the two blanket cylinders.

In the conventional sheet-fed offset rotary printing press described above, as the two laser inscribing systems respectively form images on the two plate cylinders, the identical images formed on the two plate cylinders tend to misregister from each other. Then, not only the printing quality decreases, but also extra time is required for adjustment to correct the misregister, decreasing the productivity. If ink from an inking unit undesirably attaches to that surface of the impression cylinder which does not hold a paper sheet through a blanket cylinder, a paper sheet to be fed next may undesirably be soiled.

### SUMMARY OF THE INVENTION

It is an object of the present invention to provide a sheet-fed offset rotary printing press which can improve the printing quality.

It is another object of the present invention to provide a sheet-fed offset rotary printing press which can improve the productivity.

In order to achieve the above objects, according to the present invention, there is provided a sheet-fed offset rotary printing press comprising one plate cylinder having an outer surface on which at least one plate member is mounted, one blanket cylinder which opposes the plate cylinder and has an outer surface on which at least one blanket is mounted, the blanket cylinder having the same size as that of the plate cylinder, one impression cylinder having at least one sheet holding means for holding a sheet (or a sheet type object), one plate making device which can inscribe four printing patterns on four regions of the plate member while the plate member is mounted on the plate cylinder, four inking devices which individually supply inks to the four printing patterns of the plate member mounted on the plate cylinder through four form rollers, four roller throw-on/throw-off devices which throw on one of the four form rollers onto a corresponding one of the four printing patterns of the plate member mounted on the plate cylinder and throw off the remaining ones of the form rollers from the remaining ones of the printing patterns, and a cylinder throw-on/throw-off device which throws on the blanket cylinder immediately before the blanket cylinder, to which the inks have been supplied from the four inking devices through the plate cylinder, and the sheet held by the sheet holding means oppose each other, and throws off the blanket cylinder immediately before the blanket cylinder and the impression cylinder, while the sheet holding means does not hold a sheet, oppose each other.

### BRIEF DESCRIPTION OF THE DRAWINGS

FIG. 1 is a side view showing the schematic structure of a sheet-fed offset rotary printing press according to the first embodiment of the present invention;

FIG. 2 is a side view showing the arrangement of the cylinders shown in FIG. 1;

FIG. 3 is a side view of a cylinder throw-on/throw-off device in the sheet-fed offset rotary printing press shown in FIG. 1;

FIG. 4 is a side view showing the main part to explain a throw-on/throw-off device for each of ink form rollers shown in FIG. 1;

FIGS. 5A and 5B are model views showing the main part to explain feed- and delivery-side impression cylinder gripper opening/closing devices, respectively;

FIGS. 6A and 6B are sequence charts of the sheet-fed offset rotary printing press shown in FIG. 1, when four-color printing is to be performed on six paper sheets, for explaining the printing states of the paper sheets fed to the respective phases of the impression cylinder;

FIG. 7 is a sequence chart of the sheet-fed offset rotary printing press shown in FIG. 1, when four-color printing is to be performed on one paper sheet, for explaining the printing states of the paper sheet fed to the respective phases of the impression cylinder;

FIGS. 8A and 8B are sequence charts of the sheet-fed offset rotary printing press shown in FIG. 1, when two-color printing is to be performed on six paper sheets, for explaining the printing states of the paper sheets fed to the respective phases of the impression cylinder;

FIG. 9 is a sequence chart of the sheet-fed offset rotary printing press shown in FIG. 1, when four-color printing is to be performed on three paper sheets, for explaining the printing state of the paper sheets fed to the respective phases of the impression cylinder; and

FIG. 10 is a model view showing an impression cylinder for a sheet-fed offset rotary printing press according to the second embodiment of the present invention.

### DESCRIPTION OF THE PREFERRED EMBODIMENTS

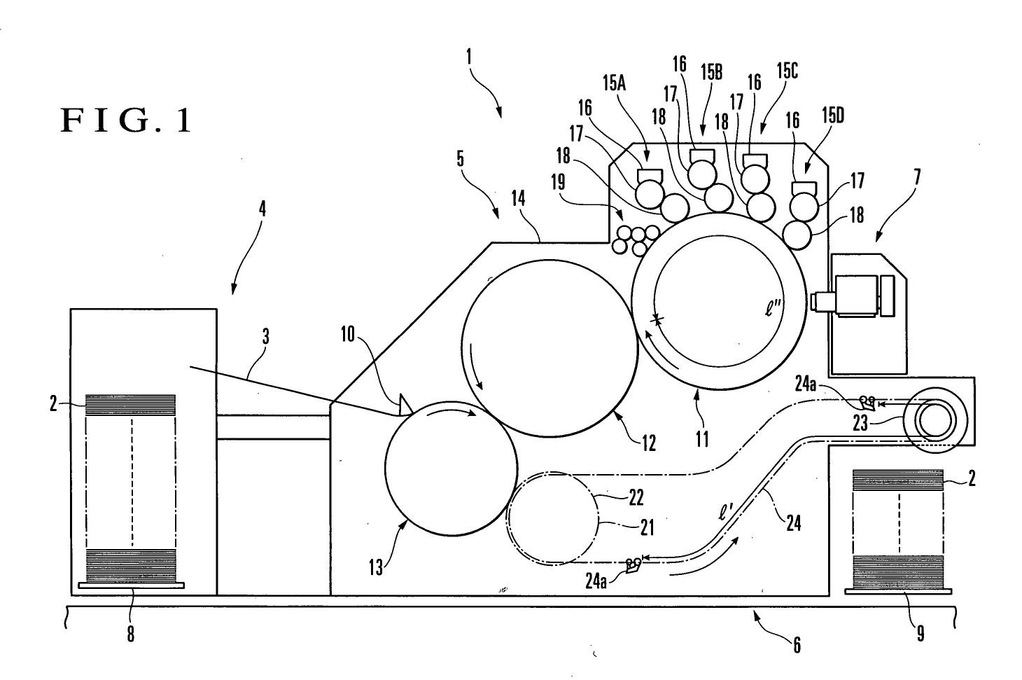

A sheet-fed offset rotary printing press according to the first embodiment of the present invention will be described with reference to FIGS. 1 to 5B.

Referring to FIG. 1, a sheet-fed offset rotary printing press 1 includes a feeder 4 which feeds paper sheet 2 stacked on a pile board 8 onto a feeder board 3 one by one, a printing unit 5 which prints the fed paper sheet 2, a delivery unit 6 which conveys the printed paper sheet 2 and delivers it onto a pile board 9 to stack it there, and a plate making device 7 which plate-makes a plate mounted on the outer surface of a plate cylinder 11 that forms the printing unit 5. The paper sheet 2 fed onto the feeder board 3 is positioned by a registration device (not shown) and gripped by the grippers of a swing arm shaft gripper 10. After that, the paper sheet 2 is conveyed to the outer surface of an impression cylinder 13 that forms the printing unit 5, and gripping-changed to gripper devices 36A to 36C of the impression cylinder 13 by a gripper opening/closing device 60 (to be described later).

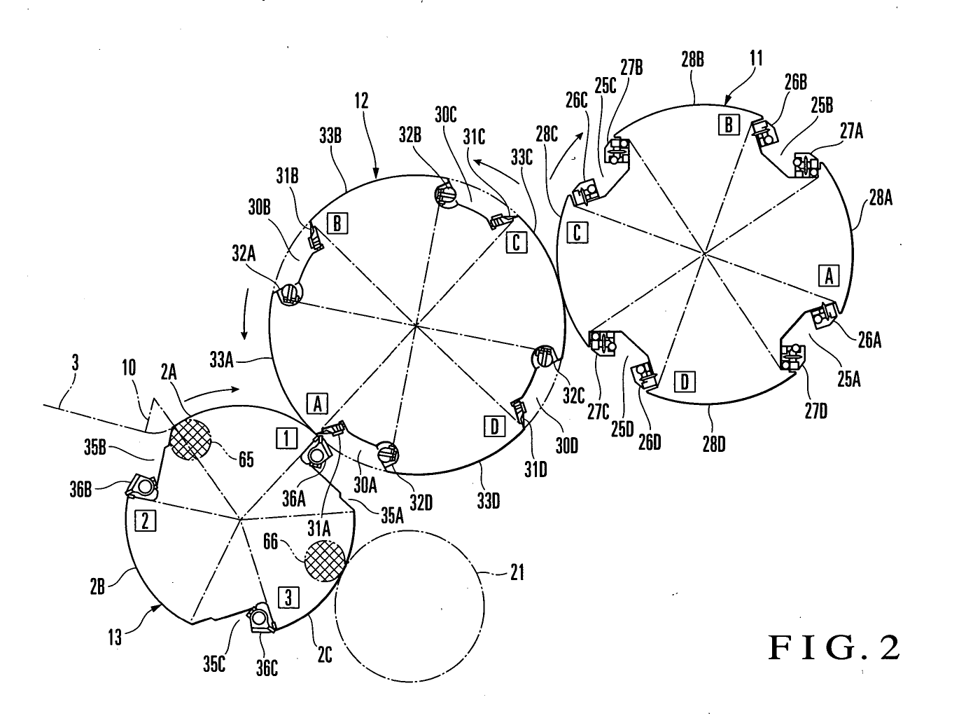

The printing unit 5 has the plate cylinder 11 with an outer surface on which printing plates 28A to 28D (FIG. 2) are mounted, a blanket cylinder 12 which is in contact with the plate cylinder 11 during printing operation and has an outer surface on which blankets 33A to 33D (FIG. 2) are mounted, the impression cylinder 13 onto/from which the blanket cylinder 12 is thrown on/off during the printing operation by a cylinder throw-on/throw-off device 39 (to be described later), and a pair of frames 14 which support the three cylinders 11, 12, and 13 and oppose each other at a predetermined gap. The two end shafts of each of the plate cylinder 11 and impression cylinder 13 are rotatably, axially supported by the pair of frames 14 through bearings (not shown). The two end shafts of the blanket cylinder 12 are rotatably, axially supported by eccentric bearings 41 (to be described later) fitted on the pair of frames 14.

Four inking devices 15A to 15D supply inks of different colors to the plate cylinder 11. The inking device 15A supplies black ink, the inking device 15B supplies yellow ink, the inking device 15C supplies red ink, and the inking device 15D supplies blue ink. Each of the inking devices 15A to 15D includes an ink fountain 16, an anilox roller 17 which extracts the ink from the ink fountain 16, and an ink form roller 18 which is in contact with the anilox roller 17 and brought into selective contact with the outer surface of the plate cylinder 11 by a roller throw-on/throw-off device 54 (to be described later) to supply the ink to the plate (28A to 28D) mounted on the outer surface of the plate cylinder 11. A dampener 19 supplies dampening water to the outer surface of the plate cylinder 11.

The delivery unit 6 has a take-off cylinder 21 in contact with the impression cylinder 13, a pair of front sprockets 22 which line up to be coaxial with the take-off cylinder 21, a pair of rear sprockets 23 rotatably supported at the rear portions of the frames 14 to oppose each other, and a pair of delivery chains 24 looped between the sprockets 22 and 23. Each of the pair of delivery chains 24 has two delivery grippers 24a at a predetermined distance 1′ in its traveling direction. The distance between the delivery grippers 24a is set to correspond to a circumferential length l″ of one revolution of the plate cylinder 11.

In this arrangement, paper sheet gripping change is performed, at the contact portion of the impression cylinder 13 and take-off cylinder 21, between an odd number of the gripper devices 36A to 36C of the impression cylinder 13 and the delivery grippers 24a of the delivery chains 24 by the gripper opening/closing device 60 (to be described later). Subsequently, the delivery chains 24 travel to convey the paper sheet backward, and the paper sheet is released from the delivery grippers 24a so that it is delivered and stacked on the pile board 9.

The structures of the plate cylinder 11, blanket cylinder 12, and impression cylinder 13 will be described with reference to FIG. 2. Referring to FIG. 2, the plate cylinder 11 has a quadruple size. Four notches 25A to 25D are formed in the outer surface of the plate cylinder 11 at positions equiangularly phase-shifted from each other in the circumferential direction, so as to extend in the entire portion of the outer surface in the axial direction. Each of leading edge holding mechanisms 26A to 26D for holding the leading edge of the plate and each of trailing edge holding mechanisms 27A to 27D for holding the trailing edge of the plate are arranged respectively at the two ends of the corresponding one of the notches 25A to 25D. The four plates 28A to 28D are mounted between the leading edge holding mechanisms 26A to 26D and trailing edge holding mechanisms 27A to 27D of the notches 25A to 25D such that each plate covers an outer surface portion between the leading edge holding mechanism of one notch and the trailing edge holding mechanism of the adjacent notch. More specifically, the plate cylinder 11 has four printing surfaces 28A to 28D equidistantly in the circumferential direction. The regions of the four printing surfaces 28A to 28D will be referred to as phases “A”, “B”, “C”, and “D” of the plate cylinder 11 hereinafter.

The blanket cylinder 12 has a quadruple size. Four notches 30A to 30D are formed in the outer surface of the blanket cylinder 12 at positions equiangularly phase-shifted from each other in the circumferential direction, so as to extend in the entire portion of the outer surface in the axial direction. Each of leading edge holding mechanisms 31A to 31D for holding the leading edge of the plate and each of trailing edge holding mechanisms 32A to 32D for holding the trailing edge of the plate are arranged respectively at the two ends of the corresponding one of the notches 30A to 30D. The four blankets 33A to 33D are mounted between the leading edge holding mechanisms 31A to 31D and trailing edge holding mechanisms 32A to 32D of adjacent ones of the notches 30A to 30D such that each blanket covers an outer surface portion between the leading edge holding mechanism of one notch and the trailing edge holding mechanism of the adjacent notch.

The phase of the blanket cylinder 12 with respect to the plate cylinder 11 is set such that the four notches 30A to 30D oppose the corresponding ones of the four notches 25A to 25D of the plate cylinder 11. Thus, the four printing surfaces 28A to 28D of the plate cylinder 11 respectively come into contact with the four blankets 33A to 33D of the blanket cylinder 12. More specifically, the four blankets 33A to 33D of the blanket cylinder 12 serve as the four printing surfaces 33A to 33D formed equidistantly in the circumferential direction. The regions of the four printing surfaces 33A to 33D will be referred to as phases “A”, “B”, “C”, and “D” of the blanket cylinder 12 hereinafter.

The impression cylinder 13 has a triple size. Three notches 35A to 35C are formed in the outer surface of the impression cylinder 13 at positions equiangularly phase-shifted from each other in the circumferential direction, so as to extend in the entire portion of the outer surface in the axial direction. The gripper devices 36A to 36C for gripping the leading edge of the paper sheet are arranged, each at one end of the corresponding one of the notches 35A to 35C, equidistantly in the circumferential direction. The phase of the impression cylinder 13 with respect to the blanket cylinder 12 is set such that the three notches 35A to 35C oppose either ones of the four notches 30A to 30D of the blanket cylinder 12. Thus, each of paper sheets 2A to 2C respectively gripped by the gripper devices 36A to 36C of the impression cylinder 13 is printed by either one of the printing surfaces 33A to 33D of the blanket cylinder 12 at the contact portion of the impression cylinder 13 and blanket cylinder 12. The regions of the paper sheets 2A to 2C gripped by the gripper devices 36A to 36C of the impression cylinder 13 will be referred to as phases “1”, “2”, and “3” of the impression cylinder 13 hereinafter.

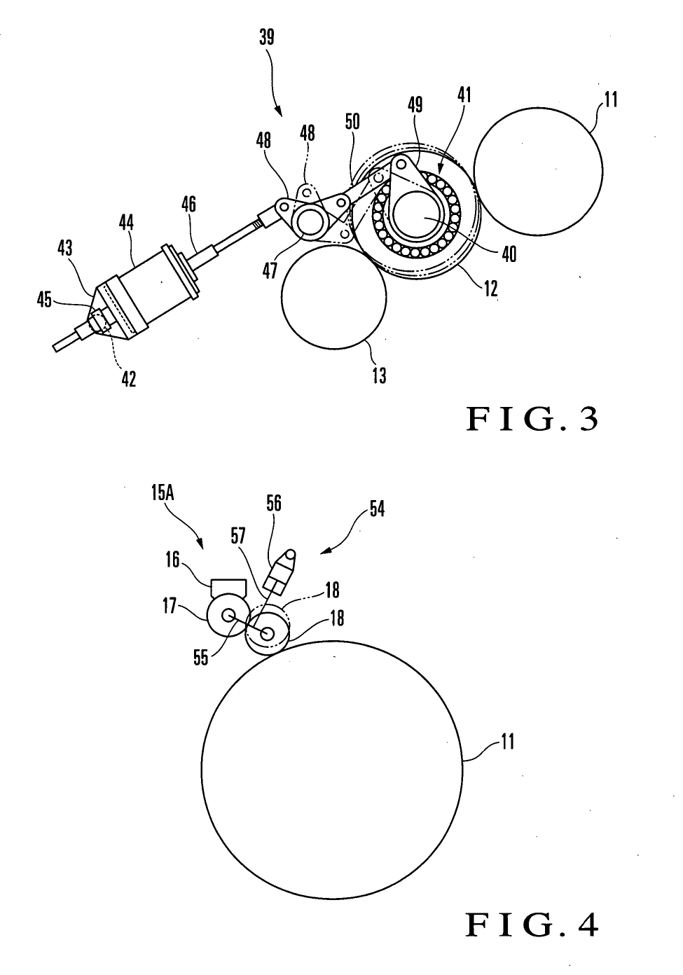

The cylinder throw-on/throw-off device 39 which throws on/off the plate cylinder 11 and impression cylinder 13 will be described with reference to FIG. 3. Referring to FIG. 3, two end shafts 40 of the blanket cylinder 12 are rotatably supported by the two eccentric bearings 41 fitted on the pair of frames 14. A bracket 43 is supported by a stud 42 projecting outside one frame 14, and a stepping motor 44 is fixed to the bracket 43. When a nut 45 is driven to rotate by the stepping motor 44, a driving rod 46 threadably engaging with the threaded portion of the nut 45 moves forward/backward. The central portion of an L-shaped connecting lever 48 is axially mounted on a lever shaft 47 rotatably axially supported by the frame 14. The distal end of the driving rod 46 is pivotally mounted on one end of the connecting lever 48.

A driving lever 49 fixed to the outer ring of one eccentric bearing 41 and the other end of the connecting lever 48 are connected to each other through a rod 50. In this structure, when the driving rod 46 moves backward, the connecting lever 48 pivots counterclockwise about the lever shaft 47 as the center as indicated by a solid line in FIG. 3, so that the eccentric bearing 41 pivots through the rod 50 and driving lever 49. Thus, the blanket cylinder 12 comes into contact with the plate cylinder 11 and impression cylinder 13.

When the driving rod 46 is stretched, the connecting lever 48 pivots to a position between the position indicated by a solid line and the position indicated by an alternate long and two short dashed line, to realize a so-called blanket cylinder-impression cylinder throw-off (to be referred to as B-I throw-off) state wherein the blanket cylinder 12 while kept in contact with the plate cylinder 11 is separated from the impression cylinder 13. When the driving rod 46 is further stretched, the connecting lever 48 pivots to the position indicated by the alternate long and two short dashed line, and the blanket cylinder 12 separates from the plate cylinder 11 as well, thus performing impression throw-off.

The ink form roller throw-on/throw-off devices 54 will be described with reference to FIG. 4. The ink form roller throw-on/throw-off devices 54 are provided to the four inking devices 15A to 15D, respectively, and have the same structure. The ink form roller throw-on/throw-off device 54 provided to the inking device 15A will be described hereinafter, and a description on the remaining inking devices 15B to 15D will be omitted.

An arm 55 has one end pivotally supported by the central portion of the anilox roller 17. The other end of the arm 55 is attached to the central portion of the ink form roller 18. A throw-on/throw-off pneumatic cylinder 56 has a cylinder end pivotally supported by the frame 14. The distal end of a rod 57 of the pneumatic cylinder 56 is pivotally mounted on the arm 55. In this structure, when the pneumatic cylinder 56 is actuated to move the rod 57 forward, the ink form roller 18 comes into contact with the outer surface of the plate cylinder 11. When the rod 57 moves backward, the ink form roller 18 separates from the outer surface of the plate cylinder 11.

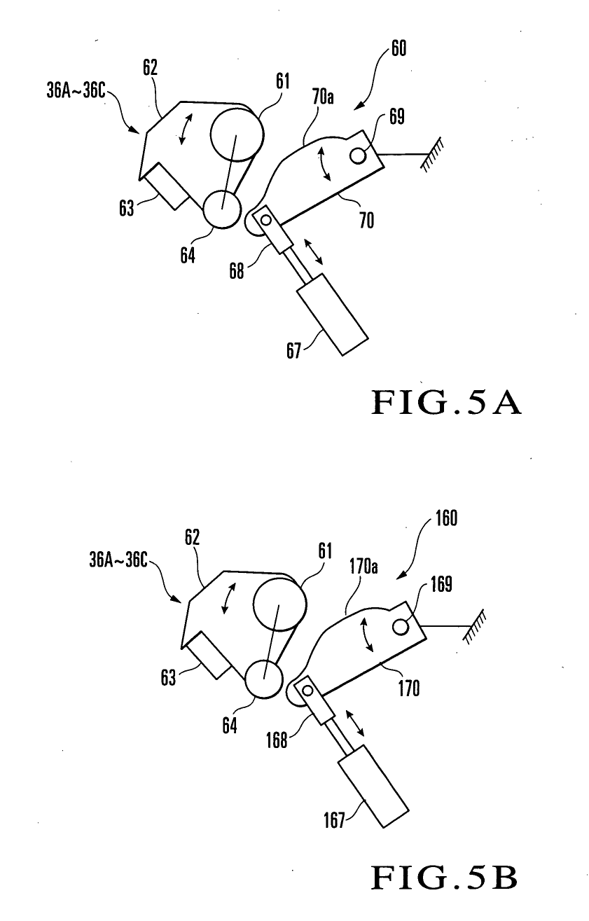

The gripper opening/closing device 60 and a gripper opening/closing device 160 which open/close the gripper devices 36A to 36C of the impression cylinder 13 will be described with reference to FIGS. 5A and 5B. Referring to FIGS. 5A and 5B, each of the gripper devices 36A to 36C has a plurality of grippers 62 axially mounted on a gripper shaft 61 at substantially predetermined intervals and a gripper pad 63 which grips the leading edge of the paper sheet together with the grippers 62. The gripper opening/closing device 60 is attached to the frames 14 in relation to a gripping change position 65, with respect to the swing arm shaft gripper 10, surrounded by an alternate long and two short dashed line and indicated by hatched grids in FIG. 2. The gripper opening/closing device 160 is attached to the frames 14 in relation to a gripping change position 66, with respect to the delivery grippers 24a of the delivery chains 24, which is surrounded by an alternate long and two short dashed line and indicated by hatched grids in FIG. 2.

The gripper opening/closing devices 60 and 160 respectively have pneumatic cylinders 67 and 167 and cams 70 and 170. The cylinder ends of the pneumatic cylinders 67 and 167 are respectively pivotally supported by the frames 14. A rod 68 of the pneumatic cylinder 67 is pivotally mounted on one end of the cam 70. The other end of the cam 70 is pivotally supported by the frames 14 through a pin 69. A rod 168 of the pneumatic cylinder 167 is pivotally mounted on one end of the cam 170. The other end of the cam 170 is pivotally supported by the frames 14 through a pin 169.

In this structure, when the rods 68 and 168 of the pneumatic cylinders 67 and 167 move forward, the cams 70 and 170 pivot clockwise in FIGS. 5A and 5B about the pins 69 and 169 as the centers, and the cams 70 and 170 advance to operative positions where their large-diameter portions 70a and 170a can engage with the wheel 64 of the gripper shaft 61. In this state, when the impression cylinder 13 rotates and the gripper devices 36A to 36C are positioned at the gripping change positions 65 and 66, the wheel 64 engages with the large-diameter portions 70a and 170a of the cams 70 and 170, and the grippers 62 pivot clockwise in FIGS. 5A and 5B together with the gripper shaft 61. Then, the grippers 62 open from the gripper pad 63 momentarily. Accordingly, gripping change of the paper sheet is performed with respect to the swing arm shaft gripper 10 or the delivery grippers 24a of the delivery chains 24.

When the rods 68 and 168 of the pneumatic cylinders 67 and 167 move backward, the cams 70 and 170 pivot counterclockwise in FIGS. 5A and 5B about the pins 69 and 169 as the centers. Thus, the cams 70 and 170 move backward to retreat positions where their large-diameter portions 70a and 170a do not engage with the wheel 64 of the gripper shaft 61. In this state, even when the impression cylinder 13 rotates and the gripper devices 36A to 36C are positioned at the gripping change positions 65 and 66, the wheel 64 does not engage with the large-diameter portions 70a and 170a of the cams 70 and 170. Therefore, gripping change of the paper sheet is not performed with respect to the swing arm shaft gripper 10 or the delivery grippers 24a of the delivery chains 24.

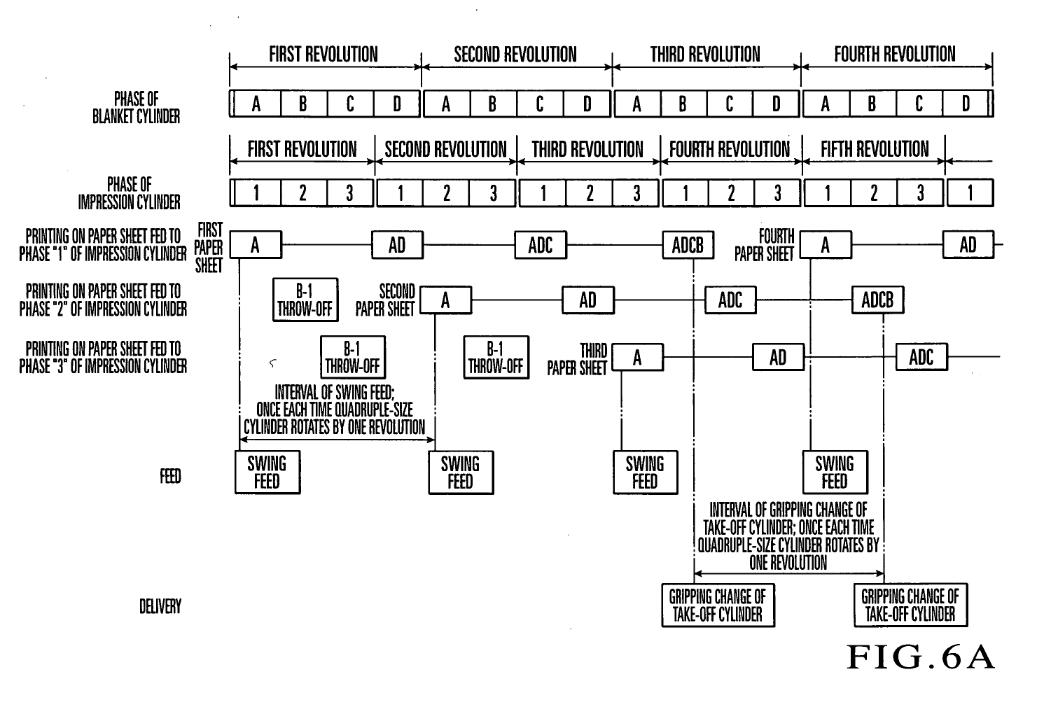

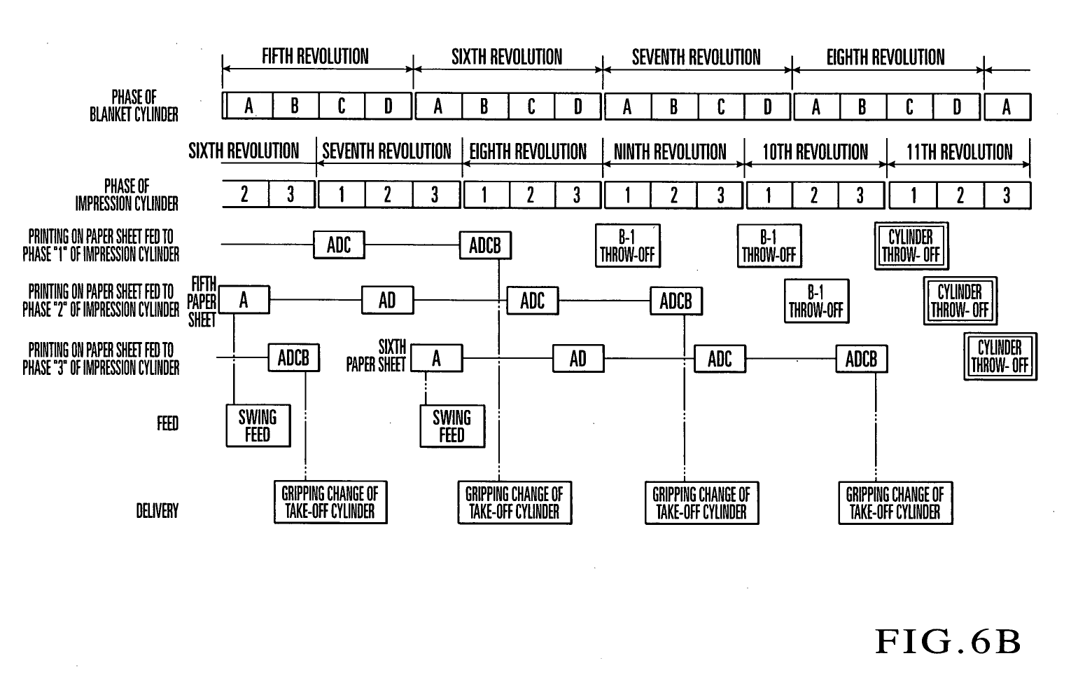

A case will be described with reference to FIGS. 6A and 6B wherein four-color printing is to be performed on each of six paper sheets with the sheet-fed offset rotary printing press having the above structure.

First, four plates 28A to 28D which are not plate-made yet are mounted on the plate cylinder 11, and are plate-made by the plate making device 7. Four different-color inks are respectively supplied to the plate-made plates 28A to 28D by the four inking devices 15A to 15D. More specifically, black ink is supplied to the plate 28A by the ink form roller 18 of the inking device 15A. Yellow ink is supplied to the plate 28B by the ink form roller 18 of the inking device 15B. Red ink is supplied to the plate 28C by the ink form roller 18 of the inking device 15C. Blue ink is supplied to the plate 28D by the ink form roller 18 of the inking device 15D. The inks of the four different colors supplied to the plates 28A to 28D are transferred to the blankets 33A to 33D, with which the plates 28A to 28D respectively come into contact, of the blanket cylinder 12 as black, yellow, red, and blue patterns.

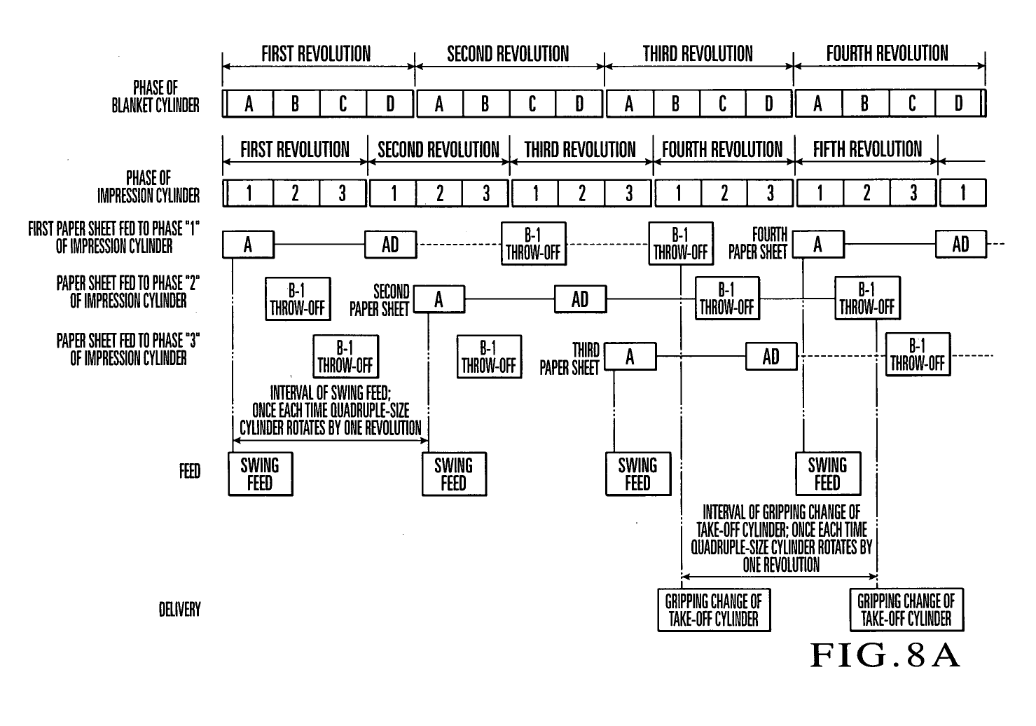

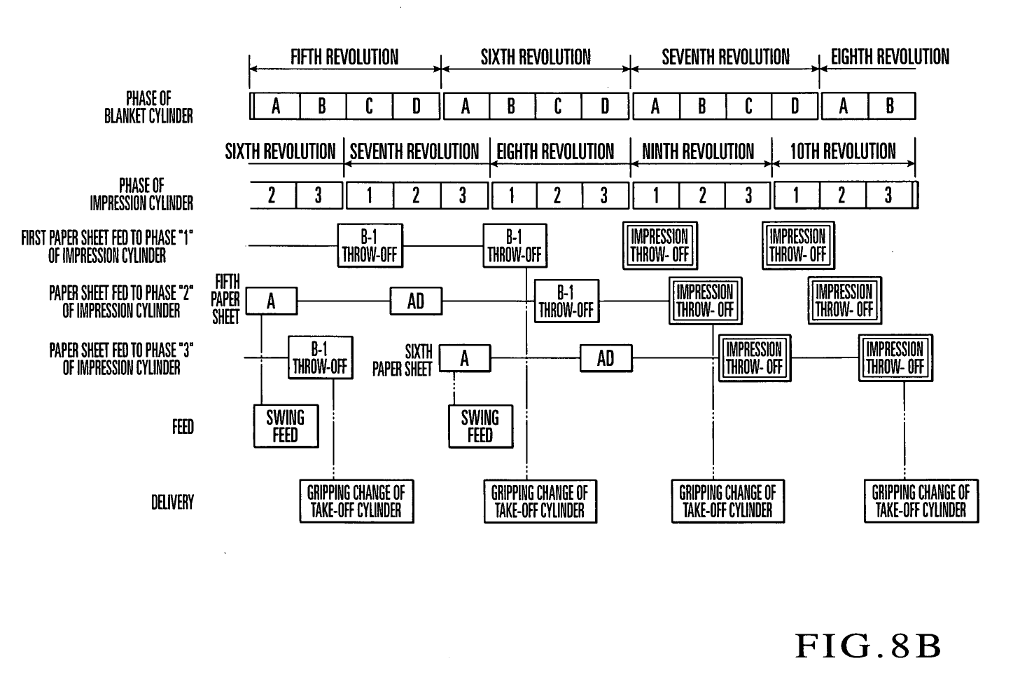

After the inks are transferred, when a paper sheet 2 is fed by the feeder 4 onto the feeder board 3, it is positioned by a register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36A of the impression cylinder 13. When the gripping change is ended, the rod 68 of the pneumatic cylinder 67 moves backward, and the large-diameter portion 70a of the cam 70 is positioned at the retreat position. In this state, when the impression cylinder 13 rotates clockwise in FIG. 2 by ⅓ revolution, the gripper device 36A opposes the leading edge holding mechanism 31A of the blanket cylinder 12. Immediately before this, the blanket cylinder 12 is brought into contact with the impression cylinder 13 by the cylinder throw-on/throw-off device 39. The impression cylinder 13 further pivots to bring the phase “A” of the blanket cylinder 12 and the phase “1” of the impression cylinder 13 into contact with each other. Thus, a black pattern is printed on the first paper sheet, as shown in FIGS. 8A and 8B.

Immediately before the phase “2” of the impression cylinder 13 and the phase “B” of the blanket cylinder 12 oppose each other, the blanket cylinder 12 is separated from the impression cylinder 13 by the cylinder throw-on/throw-off device 39 to perform B-I throw-off. The B-I throw-off is held while the impression cylinder 13 and blanket cylinder 12 rotate by ⅔ revolution and 2/4 revolution, respectively, until immediately before the phase “1” of the impression cylinder 13 comes into contact with the phase “D” of the blanket cylinder 12. As the blanket cylinder 12 does not come into contact with the phase “2” nor “3” of the impression cylinder 13 which does not grip a paper sheet, set-off on cylinder does not occur on the outer surface of the impression cylinder 13.

Immediately before the phase “1” of the impression cylinder 13 comes into contact with the phase “D” of the blanket cylinder 12, the B-I throw-off is canceled by the cylinder throw-on/throw-off device 39. The blanket cylinder 12 comes into contact with the impression cylinder 13, and a blue pattern is printed on the first paper sheet. Subsequently, when a paper sheet 2 is fed by the feeder 4 onto the feeder board 3, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 of the pneumatic cylinder 67 is positioned at the operative position, and the leading edge of the paper sheet 2 is gripping-changed to the gripper device 36B of the impression cylinder 13.

When the gripping change is ended, the rod 68 of the pneumatic cylinder 67 of the gripper opening/closing device 60 moves backward, and the large-diameter portion 70a of the cam 70 is positioned at the retreat position. The impression cylinder 13 and blanket cylinder 12 rotate to bring the phase “2” of the impression cylinder 13 and the phase “A” of the blanket cylinder 12 into contact with each other. Thus, a black pattern is printed on the second paper sheet.

The impression cylinder 13 and blanket cylinder 12 further rotate by ⅓ revolution and ¼ revolution, respectively. Immediately before the phase “3” of the impression cylinder 13 comes into contact with the phase “B” of the blanket cylinder 12, the blanket cylinder 12 is separated from the impression cylinder 13 by the cylinder throw-on/throw-off device 39 to perform B-I throw-off. As the blanket cylinder 12 does not come into contact with the phase “3” of the impression cylinder 13 which does not grip a paper sheet, set-off on cylinder does not occur on the outer surface of the impression cylinder 13.

The impression cylinder 13 and blanket cylinder 12 further rotate. Immediately before the phase “1” of the impression cylinder 13 comes into contact with the phase “C” of the blanket cylinder 12, the B-I throw-off is canceled by the cylinder throw-on/throw-off device 39. The blanket cylinder 12 comes into contact with the impression cylinder 13, and a red pattern is printed on the first paper sheet.

The impression cylinder 13 and blanket cylinder 12 further rotate by ⅓ revolution and ¼ revolution, respectively, to bring the phase “2” of the impression cylinder 13 into contact with the phase “D” of the blanket cylinder 12. Thus, a blue pattern is printed on the second paper sheet.

At this time, when a third paper sheet which is fed onto the feeder board 3 and positioned by the register device (not shown) is gripped by the grippers of the swing arm shaft gripper 10 and conveyed to the outer surface of the impression cylinder 13, the rod 68 of the pneumatic cylinder 67 of the gripper opening/closing device 60 moves forward. Then, the large-diameter portion 70a of the cam 70 is positioned at the operative position, and the leading edge of the paper sheet 2 is gripping-changed to the gripper device 36C of the impression cylinder 13. When the gripping change is ended, the rod 68 of the pneumatic cylinder 67 of the gripper opening/closing device 160 moves backward, and the large-diameter portion 70a of the cam 70 is positioned at the retreat position. The impression cylinder 13 and blanket cylinder 12 rotate to bring the phase “3” of the impression cylinder 13 and the phase “A” of the blanket cylinder 12 into contact with each other. Thus, a black pattern is printed on the third paper sheet.

The impression cylinder 13 and blanket cylinder 12 further rotate by ⅓ revolution and ¼ revolution, respectively, to bring the phase “1” of the impression cylinder 13 into contact with the phase “B” of the blanket cylinder 12. Thus, a yellow pattern is printed on the first paper sheet. At this time, the rod 168 of the pneumatic cylinder 167 of the gripper opening/closing device 160 moves forward, and the large-diameter portion 170a of the cam 170 is positioned at the operative position.

When the gripper device 36A of the impression cylinder 13 opposes the delivery grippers 24a of the delivery chains 24, the first paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The first paper sheet is thus stacked on the pile board 9. When the gripping change is ended, the rod 168 of the pneumatic cylinder 167 of the gripper opening/closing device 160 moves backward, and the large-diameter portion 170a of the cam 170 is positioned at the retreat position.

The impression cylinder 13 and blanket cylinder 12 further rotate by ⅓ revolution and ¼ revolution, respectively, to bring the phase “2” of the impression cylinder 13 into contact with the phase “C” of the blanket cylinder 12. Thus, a red pattern is printed on the second paper sheet.

The impression cylinder 13 and blanket cylinder 12 further rotate by ⅓ revolution and ¼ revolution, respectively, to bring the phase “3” of the impression cylinder 13 into contact with the phase “D” of the blanket cylinder 12. Thus, a blue pattern is printed on the third paper sheet.

At this time, when the fourth paper sheet which is fed onto the feeder board 3 and positioned by the register device (not shown) is gripped by the grippers of the swing arm shaft gripper 10 and conveyed to the outer surface of the impression cylinder 13, the rod 68 of the pneumatic cylinder 67 of the gripper opening/closing device 60 moves forward. Then, the large-diameter portion 70a of the cam 70 is positioned at the operative position, and the leading edge of the paper sheet 2 is gripping-changed to the gripper device 36A of the impression cylinder 13. When the gripping change is ended, the rod 68 of the pneumatic cylinder 67 of the gripper opening/closing device 60 moves backward, and the large-diameter portion 70a of the cam 70 is positioned at the retreat position. The impression cylinder 13 and blanket cylinder 12 rotate to bring the phase “1” of the impression cylinder 13 and the phase “A” of the blanket cylinder 12 into contact with each other. Thus, a black pattern is printed on the fourth paper sheet.

The impression cylinder 13 and blanket cylinder 12 further rotate by ⅓ revolution and ¼ revolution, respectively, to bring the phase “2” of the impression cylinder 13 into contact with the phase “B” of the blanket cylinder 12. Thus, a yellow pattern is printed on the second paper sheet. At this time, the rod 168 of the pneumatic cylinder 167 moves forward, and the large-diameter portion 170a of the cam 170 is positioned at the operative position.

When the gripper device 36B of the impression cylinder 13 opposes the delivery grippers 24a of the delivery chains 24, the second paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The second paper sheet is thus stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate by ⅓ revolution and ¼ revolution, respectively, to bring the phase “3” of the impression cylinder 13 into contact with the phase “C” of the blanket cylinder 12. Thus, a red pattern is printed on the third paper sheet.

The impression cylinder 13 and blanket cylinder 12 further rotate by ⅓ revolution and ¼ revolution, respectively, to bring the phase “1” of the impression cylinder 13 into contact with the phase “D” of the blanket cylinder 12. Thus, a blue pattern is printed on the fourth paper sheet.

Then, when a paper sheet is fed onto the feeder board 3 by the feeder 4, it is positioned by the register device (not shown) and gripped by the grippers of the swing arm shaft gripper 10, and after that conveyed to the outer surface of the impression cylinder 13. At this time, the rod 68 of the pneumatic cylinder 67 which forms the gripper opening/closing device 60 moves forward. Then, the large-diameter portion 70a of the cam 70 is positioned at the operative position, so that the leading edge of the paper sheet 2 is gripping-changed to the gripper device 36B of the impression cylinder 13. When the gripping change is ended, the rod 68 of the pneumatic cylinder 67 moves backward, and the large-diameter portion 70a of the cam 70 is positioned at the retreat position. The impression cylinder 13 and blanket cylinder 12 rotate to bring the phase “2” of the impression cylinder 13 and the phase “A” of the blanket cylinder 12 into contact with each other, as shown in FIG. 6A. Thus, a black pattern is printed on the fifth paper sheet.

The impression cylinder 13 and blanket cylinder 12 further rotate by ⅓ revolution and ¼ revolution, respectively, to bring the phase “3” of the impression cylinder 13 into contact with the phase “B” of the blanket cylinder 12. Thus, a yellow pattern is printed on the third paper sheet. At this time, the rod 168 of the pneumatic cylinder 167 moves forward, and the large-diameter portion 170a of the cam 170 is positioned at the operative position.

When the gripper device 36C of the impression cylinder 13 opposes the delivery grippers 24a of the delivery chains 24, the third paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The third paper sheet is thus delivered and stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate by ⅓ revolution and ¼ revolution, respectively, to bring the phase “1” of the impression cylinder 13 into contact with the phase “C” of the blanket cylinder 12. Thus, a red pattern is printed on the fourth paper sheet.

The impression cylinder 13 and blanket cylinder 12 further rotate by ⅓ revolution and ¼ revolution, respectively, to bring the phase “2” of the impression cylinder 13 into contact with the phase “D” of the blanket cylinder 12. Thus, a blue pattern is printed on the fifth paper sheet.

Then, when a paper sheet is fed onto the feeder board 3 by the feeder 4, it is positioned by the register device (not shown) and gripped by the grippers of the swing arm shaft gripper 10, and after that conveyed to the outer surface of the impression cylinder 13. At this time, the rod 68 of the pneumatic cylinder 67 which forms the gripper opening/closing device 60 moves forward. Then, the large-diameter portion 70a of the cam 70 is positioned at the operative position, and the leading edge of the paper sheet 2 is gripping-changed to the gripper device 36C of the impression cylinder 13. When the gripping change is ended, the rod 68 of the pneumatic cylinder 67 moves backward, and the large-diameter portion 70a of the cam 70 is positioned at the retreat position. The impression cylinder 13 and blanket cylinder 12 rotate to bring the phase “3” of the impression cylinder 13 and the phase “A” of the blanket cylinder 12 into contact with each other. Thus, a black pattern is printed on the sixth paper sheet.

The impression cylinder 13 and blanket cylinder 12 further rotate by ⅓ revolution and ¼ revolution, respectively, to bring the phase “1” of the impression cylinder 13 into contact with the phase “B” of the blanket cylinder 12. Thus, a yellow pattern is printed on the fourth paper sheet. At this time, the rod 168 of the pneumatic cylinder 167 moves forward, and the large-diameter portion 170a of the cam 170 is positioned at the operative position.

When the gripper device 36A of the impression cylinder 13 opposes the delivery grippers 24a of the delivery chains 24, the fourth paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and is released above the pile board 9 of the delivery unit 6. The fourth paper sheet is thus delivered and stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate by ⅓ revolution and ¼ revolution, respectively, to bring the phase “2” of the impression cylinder 13 into contact with the phase “C” of the blanket cylinder 12. Thus, a red pattern is printed on the fifth paper sheet.

The impression cylinder 13 and blanket cylinder 12 further rotate by ⅓ revolution and ¼ revolution, respectively, to bring the phase “3” of the impression cylinder 13 into contact with the phase “D” of the blanket cylinder 12. Thus, a blue pattern is printed on the sixth paper sheet.

The impression cylinder 13 and blanket cylinder 12 further rotate by ⅓ revolution and ¼ revolution, respectively. Immediately before the phase “1” of the impression cylinder 13 comes into contact with the phase “A” of the blanket cylinder 12, the blanket cylinder 12 is separated from the impression cylinder 13 by the cylinder throw-on/throw-off device 39 to perform B-I throw-off. As the blanket cylinder 12 does not come into contact with the phase “1” of the impression cylinder 13 which does not grip a paper sheet, set-off on cylinder does not occur on the outer surface of the impression cylinder 13.

The impression cylinder 13 and blanket cylinder 12 further rotate by ⅓ revolution and ¼ revolution, respectively, to bring the phase “2” of the impression cylinder 13 into contact with the phase “B” of the blanket cylinder 12. Thus, a yellow pattern is printed on the fifth paper sheet. At this time, the rod 168 of the pneumatic cylinder 167 moves forward, and the large-diameter portion 170a of the cam 170 is positioned at the operative position.

When the gripper device 36B of the impression cylinder 13 opposes the delivery grippers 24a of the delivery chains 24, the fifth paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The fifth paper sheet is thus stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate by ⅓ revolution and ¼ revolution, respectively, to bring the phase “3” of the impression cylinder 13 into contact with the phase “C” of the blanket cylinder 12. Thus, a red pattern is printed on the sixth paper sheet.

The impression cylinder 13 and blanket cylinder 12 further rotate by ⅓ revolution and ¼ revolution, respectively. Immediately before the phase “1” of the impression cylinder 13 comes into contact with the phase “D” of the blanket cylinder 12, the blanket cylinder 12 is separated from the impression cylinder 13 by the cylinder throw-on/throw-off device 39 to perform B-I throw-off. As the blanket cylinder 12 does not come into contact with the phase “1” of the impression cylinder 13 which does not grip a paper sheet, set-off on cylinder does not occur on the outer surface of the impression cylinder 13.

The B-I throw-off is held until the impression cylinder 13 and blanket cylinder 12 rotate by ⅔ revolution and 2/4 revolution, respectively. As the phase “2” of the impression cylinder 13 does not come into contact with the phase “A” of the blanket cylinder 12, set-off on cylinder does not occur on the outer surface of the impression cylinder 13.

The impression cylinder 13 and blanket cylinder 12 further rotate. Immediately before the phase “3” of the impression cylinder 13 comes into contact with the phase “B” of the blanket cylinder 12, the B-I throw-off is canceled by the cylinder throw-on/throw-off device 39. The blanket cylinder 12 comes into contact with the impression cylinder 13, and a yellow pattern is printed on the sixth paper sheet. At this time, the rod 168 of the pneumatic cylinder 167 moves forward, and the large-diameter portion 170a of the cam 170 is positioned at the operative position.

When the gripper device 36C of the impression cylinder 13 opposes the delivery grippers 24a of the delivery chains 24, the sixth paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The sixth paper sheet is thus stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate by ⅓ revolution and ¼ revolution, respectively. Immediately before the phase “1” of the impression cylinder 13 comes into contact with the phase “C” of the blanket cylinder 12, the blanket cylinder 12 is separated from the impression cylinder 13 and plate cylinder 11 by the cylinder throw-on/throw-off device 39, to perform impression throw-off. This impression throw-off operation is held while the impression cylinder 13 rotates by one revolution. Then, the printing is ended. In the printing operation described as well, a paper sheet is supplied to the impression cylinder 13 by the swing arm shaft gripper 10 each time the plate cylinder 11 rotates by one revolution.

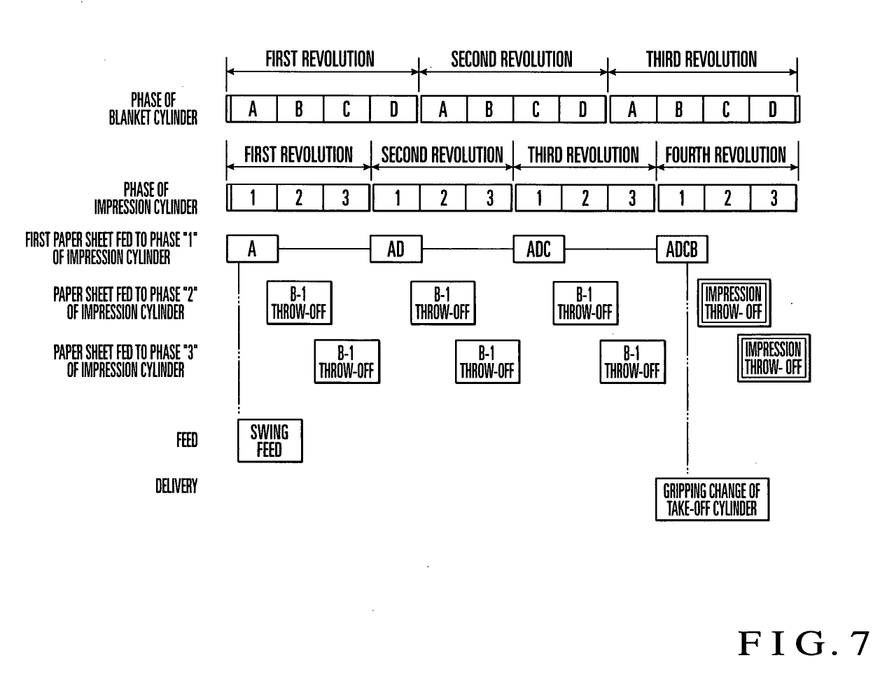

A case will be described with reference to FIG. 7 wherein four-color printing is to be performed on one paper sheet.

The throw-on/throw-off devices 39 of the ink form rollers 18 are actuated in advance. Thus, in FIG. 1, the ink form rollers 18 of the four inking devices 15A are separated and disengaged from the plate cylinder 11. The blanket cylinder 12 is separated from the impression cylinder 13 to perform B-I throw-off, and separated from the plate cylinder 11 to perform impression throw-off. In this state, in FIG. 2, four plates which are not plate-made yet are mounted between the leading edge holding mechanisms 26A to 26D and trailing edge holding mechanisms 27A to 27D of the four notches 25A to 25D of the plate cylinder 11 such that each plate covers an outer surface portion of the plate cylinder 11 between the leading edge holding mechanism of one notch and the trailing edge holding mechanism of the adjacent notch.

The plate making device 7 is then moved from one end to the other end of the plate cylinder 11 in the axial direction. Subsequently, the plate cylinder 11 is pivoted slightly, and the plate making device 7 is moved from the other end to one end of the plate cylinder 11 in the axial direction. After that, the plate making device 7 is repeatedly reciprocated in the axial direction of the plate cylinder 11. When the plate cylinder 11 rotates by ¼ revolution, the plate 28A is plate-made. The same operation is repeated three times for the remaining plates 28B to 28D, so that the plates 28B to 28D are plate-made sequentially.

In this manner, the four plates 28A to 28D on one plate cylinder 11 are plate-made by one plate making device 7. Therefore, the patterns inscribed on the plates 28A to 28D do not misregister from each other. As will be described later, when multicolor printing is to be performed on the paper sheet 2, color misregistration does not occur, and the printing quality is improved. Since adjustment for preventing color misregistration is not necessary, the productivity is improved. As one plate making device 7 suffices, the manufacturing cost of the printing press can be decreased.

Black, yellow, red, and blue inks are respectively supplied to the ink fountains 16 of the four inking devices 15A to 15D. The blanket cylinder 12 is driven by the cylinder throw-on/throw-off device 39 to come into contact with the plate cylinder 11. In this state, when the printing press is driven, the plate cylinder 11 rotates clockwise as shown in FIG. 1. When the leading edge holding mechanism 26A which holds the leading edge of the plate 28A opposes the ink form roller 18 of the inking device 15A, the ink form roller 18 is brought into contact with the plate cylinder 11 by the ink form roller throw-on/throw-off device 54 of the inking device 15A. In this state, when the trailing edge holding mechanism 27A which holds the trailing edge of the plate 28A opposes the ink form roller 18 of the inking device 15A, the ink form roller 18 is separated and thrown off from the plate cylinder 11 by the ink form roller throw-on/throw-off device 54 of the inking device 15A. Therefore, the black ink is supplied to the plate 28A by the ink form roller 18 of the inking device 15A.

When the plate cylinder 11 further pivots clockwise and the leading edge holding mechanism 26B which holds the leading edge of the plate 28B opposes the ink form roller 18 of the inking device 15B, the ink form roller 18 is brought into contact with the plate cylinder 11 by the ink form roller throw-on/throw-off device 54 of the inking device 15B. In this state, when the trailing edge holding mechanism 27B which holds the trailing edge of the plate 28B opposes the ink form roller 18 of the inking device 15B, the ink form roller 18 is separated and thrown off from the plate cylinder 11 by the ink form roller throw-on/throw-off device 54 of the inking device 15B.

The yellow ink is supplied to the plate 28B by the ink form roller 18 of the inking device 15B. Similarly, the red ink is supplied to the plate 28C by the ink form roller 18 of the inking device 15C, and the blue ink is supplied to the plate 28D by the ink form roller 18 of the inking device 15D. The operation of supplying the four different-color inks to the four plates 28A to 28D by the ink form roller throw-on/throw-off devices 54 is kept performed until the following printing operation is ended.

The four different-color inks respectively supplied to the plates 28A to 28D are transferred as a black pattern, yellow pattern, red pattern, and blue pattern to the blankets 33A to 33D, with which the plates 28A and 28D respectively come into contact, of the blanket cylinder 12.

After the four different-color inks are respectively transferred to the four plates 28A to 28D, when a paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36A of the impression cylinder 13.

When the gripping change is ended, the rod 68 of the pneumatic cylinder 67 moves backward, and the large-diameter portion 70a of the cam 70 is positioned at the retreat position. In this state, when the impression cylinder 13 rotates clockwise in FIG. 2 by ⅓ revolution, the gripper device 36A opposes the leading edge holding mechanism 31A of the blanket cylinder 12, and the blanket cylinder 12 is brought into contact with the impression cylinder 13 by the cylinder throw-on/throw-off device 39. When the impression cylinder 13 further pivots to bring the phase “A” of the blanket cylinder 12 and the phase “1” of the impression cylinder 13 into contact with each other, a black pattern is printed on the first paper sheet, as shown in FIGS. 6A and 6B.

When the notch 35B of the impression cylinder 13 and the notch 30B of the blanket cylinder 12 oppose each other, the blanket cylinder 12 is separated from the impression cylinder 13 by the cylinder throw-on/throw-off device 39 to perform B-I throw-off. The B-I throw-off is held while the impression cylinder 13 and blanket cylinder 12 rotate by ⅔ revolution and 2/4 revolution, respectively, until immediately before the phase “1” of the impression cylinder 13 comes into contact with the phase “D” of the blanket cylinder 12. As the blanket cylinder 12 does not come into contact with the phase “2” nor “3” of the impression cylinder 13 which does not grip a paper sheet, set-off on cylinder does not occur on the outer surface of the impression cylinder 13. When the phase “1” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the first paper sheet.

The impression cylinder 13 and blanket cylinder 12 further rotate. Immediately before the phase “2” of the impression cylinder 13 comes into contact with the phase “A” of the blanket cylinder 12, the blanket cylinder 12 is separated from the impression cylinder 13 by the cylinder throw-on/throw-off device 39 to perform B-I throw-off. The impression cylinder 13 and blanket cylinder 12 further rotate by ⅔ revolution and 2/4 revolution, respectively, to bring the phase “1” of the impression cylinder 13 into contact with the phase “C” of the blanket cylinder 12. The B-I throw-off is canceled by the cylinder throw-on/throw-off device 39. The blanket cylinder 12 comes into contact with the impression cylinder 13, and a red pattern is printed on the first paper sheet.

The impression cylinder 13 and blanket cylinder 12 further rotate. Immediately before the phase “2” of the impression cylinder 13 and the phase “D” of the blanket cylinder 12 come into contact with each other, the blanket cylinder 12 is separated from the impression cylinder 13 by the cylinder throw-on/throw-off device 39 to perform B-I throw-off. The B-I throw-off is held while the impression cylinder 13 and blanket cylinder 12 rotate by ⅔ revolution and 2/4 revolution, respectively, until the phase “1” of the impression cylinder 13 comes into contact with the phase “B” of the blanket cylinder 12. As the blanket cylinder 12 does not come into contact with the phase “2” nor “3” of the impression cylinder 13 which does not grip a paper sheet, set-off on cylinder does not occur on the outer surface of the impression cylinder 13. When the phase “1” of the impression cylinder 13 comes into contact with the phase “B” of the blanket cylinder 12, the B-I throw-off is canceled by the cylinder throw-on/throw-off device 39 to bring the blanket cylinder 12 into contact with the impression cylinder 13. Thus, a yellow pattern is printed on the first paper sheet. At this time, the rod 168 of the pneumatic cylinder 167 moves forward, and the large-diameter portion 170a of the cam 170 is positioned at the operative position.

When the gripper device 36A of the impression cylinder 13 opposes the delivery grippers 24a of the delivery chains 24, the first paper sheet on which the four different-color patterns are printed is gripping-changed, and the leading edge of the paper sheet is gripped by the delivery grippers 24a. Simultaneously, the blanket cylinder 12 is separated from the impression cylinder 13 and plate cylinder 11 by the cylinder throw-on/throw-off device 39, to perform impression throw-off. The paper sheet gripped by the delivery grippers 24a is conveyed as the delivery chains 24 travel, and delivered as it is released above the pile board 9 of the delivery unit 6. The paper sheet is thus stacked on the pile board 9.

As described above, multicolor printing is performed on one paper sheet gripped by the gripper device of one impression cylinder 13. Conventional gripper change of the paper sheet between impression cylinders is eliminated. Color misregistration in multicolor printing is solved, and the printing quality is improved. In the printing operation described above, the paper sheet is supplied to the impression cylinder 13 by the swing arm shaft gripper 10 each time the plate cylinder 11 rotates by one revolution.

A case will be described with reference to FIGS. 8A and 8B wherein two-color printing is to be performed on each of six paper sheets.

Four plates 28A to 28D which are not plate-made yet are mounted on the plate cylinder 11 in accordance with the same method as that described above. Of the four plates, the two plates 28A and 28D are plate-made by the plate making device 7. Subsequently, black ink is supplied to the plate 28A by the ink form roller 18 of the inking device 15A, and blue ink is supplied to the plate 28D by the ink form roller 18 of the inking device 15D. The two different-color inks supplied to the plates 28A and 28D are transferred as a black pattern and blue pattern to the blankets 33A and 33D, with which the plates 28A and 28D respectively come into contact, of the blanket cylinder 12.

After the black and blue patterns are respectively transferred to the blankets 33A and 33D, when a paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36A of the impression cylinder 13.

When the gripping change is ended, the rod 68 of the pneumatic cylinder 67 moves backward, and the large-diameter portion 70a of the cam 70 is positioned at the retreat position. In this state, when the impression cylinder 13 rotates clockwise in FIG. 2 by ⅓ revolution, the gripper device 36A opposes the leading edge holding mechanism 31A of the blanket cylinder 12. Immediately before this, the blanket cylinder 12 is brought into contact with the impression cylinder 13 by the cylinder throw-on/throw-off device 39. When the impression cylinder 13 further pivots to bring the phase “A” of the blanket cylinder 12 and the phase “1” of the impression cylinder 13 into contact with each other, a black pattern is printed on the first paper sheet, as shown in FIGS. 7A and 7B.

Immediately before the phase “2” of the impression cylinder 13 and the phase “B” of the blanket cylinder 12 oppose each other, the blanket cylinder 12 is separated from the impression cylinder 13 by the cylinder throw-on/throw-off device 39 to perform B-I throw-off. The B-I throw-off is held while the impression cylinder 13 and blanket cylinder 12 rotate by ⅔ revolution and 2/4 revolution, respectively, until immediately before the phase “1” of the impression cylinder 13 comes into contact with the phase “D” of the blanket cylinder 12. Accordingly, the blanket cylinder 12 does not come into contact with the phase “2” nor “3” of the impression cylinder 13 which does not grip a paper sheet. Immediately before the phase “1” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the first paper sheet.

Subsequently, when a second paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 of the gripper opening/closing device 60 moves forward. Thus, the large-diameter portion 70a of the cam 70 is positioned at the operative position, and the leading edge of the paper sheet 2 is gripping-changed to the gripper device 36B of the impression cylinder 13. When the gripping change is ended, the rod 68 of the pneumatic cylinder 67 moves backward, and the large-diameter portion 70a of the cam 70 is positioned at the retreat position. When the impression cylinder 13 and blanket cylinder 12 rotate to bring the phase “12” of the impression cylinder 13 and the phase “A” of the blanket cylinder 12 into contact with each other, a black pattern is printed on the second paper sheet.

The impression cylinder 13 and blanket cylinder 12 further rotate by ⅓ revolution and ¼ revolution, respectively. Immediately before the phase “3” of the blanket cylinder 12 comes into contact with the phase “B” of the blanket cylinder 12, the blanket cylinder 12 is separated from the impression cylinder 13 by the cylinder throw-on/throw-off device 39 to perform B-I throw-off. Therefore, the blanket cylinder 12 does not come into contact with the phase “3” of the impression cylinder 13 which does not grip a paper sheet.

The B-I throw-off is held while the impression cylinder 13 and blanket cylinder 12 rotate by ⅔ revolution and 2/4 revolution, respectively. Thus, the phase “1” of the impression cylinder 13 does not come into contact with the phase “C” of the blanket cylinder 12. The impression cylinder 13 and blanket cylinder 12 further rotate. Immediately before the phase “2” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the second paper sheet.

Subsequently, when a third paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36C of the impression cylinder 13. When the gripping change is ended, the rod 68 of the pneumatic cylinder 67 moves backward, and the large-diameter portion 70a of the cam 70 is positioned at the retreat position. When the impression cylinder 13 and blanket cylinder 12 further rotate to bring the phase “3” of the impression cylinder 13 and the phase “A” of the blanket cylinder 12 into contact with each other, a black pattern is printed on the third paper sheet.

The impression cylinder 13 and blanket cylinder 12 further rotate. Immediately before the phase “1” of the blanket cylinder 12 and the phase “B” of the blanket cylinder 12 come into contact with each other, the blanket cylinder 12 is separated from the impression cylinder 13 by the cylinder throw-on/throw-off device 39 to perform B-I throw-off. Therefore, the phase “1” of the impression cylinder 13 does not come into contact with the phase “B” of the blanket cylinder 12. At this time, the rod 168 of the pneumatic cylinder 167 moves forward, and the large-diameter portion 170a of the cam 170 is positioned at the operative position.

When the gripper device 36A of the impression cylinder 13 opposes the delivery grippers 24a of the delivery chains 24, the first paper sheet on which the two different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The first paper sheet is thus stacked on the pile board 9. When the gripping change is ended, the rod 68 of the pneumatic cylinder 67 of the gripper opening/closing device 60 moves backward, and the large-diameter portion 70a of the cam 70 is positioned at the retreat position.

The impression cylinder 13 and blanket cylinder 12 further rotate. Immediately before the phase “2” of the impression cylinder 13 and the phase “C” of the blanket cylinder 12 come into contact with each other, the blanket cylinder 12 is separated from the impression cylinder 13 by the cylinder throw-on/throw-off device 39 to perform B-I throw-off. Therefore, the phase “2” of the impression cylinder 13 does not come into contact with the phase “C” of the blanket cylinder 12.

The impression cylinder 13 and blanket cylinder 12 further rotate. Immediately before the phase “3” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the third paper sheet.

Subsequently, when a fourth paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36A of the impression cylinder 13. When the gripping change is ended, the rod 68 of the pneumatic cylinder 67 moves backward, and the large-diameter portion 70a of the cam 70 is positioned at the retreat position. When the impression cylinder 13 and blanket cylinder 12 further rotate to bring the phase “1” of the impression cylinder 13 and the phase “A” of the blanket cylinder 12 into contact with each other, a black pattern is printed on the fourth paper sheet.

The impression cylinder 13 and blanket cylinder 12 further rotate. Immediately before the phase “2” of the impression cylinder 13 and the phase “B” of the blanket cylinder 12 come into contact with each other, the blanket cylinder 12 is separated from the impression cylinder 13 by the cylinder throw-on/throw-off device 39 to perform B-I throw-off. Therefore, the phase “2” of the impression cylinder 13 does not come into contact with the phase “B” of the blanket cylinder 12. At this time, the rod 168 of the pneumatic cylinder 167 of the gripper opening/closing device 160 moves forward, and the large-diameter portion 170a of the cam 170 is positioned at the operative position.

When the gripper device 36B of the impression cylinder 13 opposes the delivery grippers 24a of the delivery chains 24, the second paper sheet on which the two different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The second paper sheet is thus stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate. Immediately before the phase “3” of the impression cylinder 13 and the phase “C” of the blanket cylinder 12 come into contact with each other, the blanket cylinder 12 is separated from the impression cylinder 13 by the cylinder throw-on/throw-off device 39 to perform B-I throw-off. Therefore, the phase “3” of the impression cylinder 13 does not come into contact with the phase “C” of the blanket cylinder 12.

Immediately before the phase “1” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the fourth paper sheet.

Subsequently, when a fifth paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36B of the impression cylinder 13. When the gripping change is ended, the rod 68 of the pneumatic cylinder 67 moves backward, and the large-diameter portion 70a of the cam 70 is positioned at the retreat position. When the impression cylinder 13 and blanket cylinder 12 rotate to bring the phase “2” of the impression cylinder 13 and the phase “A” of the blanket cylinder 12 into contact with each other, a black pattern is printed on the fifth paper sheet.

The impression cylinder 13 and blanket cylinder 12 further rotate. Immediately before the phase “3” of the impression cylinder 13 and the phase “B” of the blanket cylinder 12 come into contact with each other, the blanket cylinder 12 is separated from the impression cylinder 13 by the cylinder throw-on/throw-off device 39 to perform B-I throw-off. Therefore, the phase “3” of the impression cylinder 13 does not come into contact with the phase “B” of the blanket cylinder 12. At this time, the rod 168 of the pneumatic cylinder 167 of the gripper opening/closing device 160 moves forward, and the large-diameter portion 170a of the cam 170 is positioned at the operative position.

When the gripper device 36C of the impression cylinder 13 opposes the delivery grippers 24a of the delivery chains 24, the third paper sheet on which the two different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The third paper sheet is thus stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate. Immediately before the phase “1” of the impression cylinder 13 and the phase “C” of the blanket cylinder 12 come into contact with each other, the blanket cylinder 12 is separated from the impression cylinder 13 by the cylinder throw-on/throw-off device 39 to perform B-I throw-off. Therefore, the phase “1” of the impression cylinder 13 does not come into contact with the phase “C” of the blanket cylinder 12.

The impression cylinder 13 and blanket cylinder 12 further rotate. Immediately before the phase “2” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the fifth paper sheet.

Subsequently, when a sixth paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36C of the impression cylinder 13. When the gripping change is ended, the rod 68 of the pneumatic cylinder 67 moves backward, and the large-diameter portion 70a of the cam 70 is positioned at the retreat position. When the impression cylinder 13 and blanket cylinder 12 rotate to bring the phase “3” of the impression cylinder 13 and the phase “A” of the blanket cylinder 12 into contact with each other, a black pattern is printed on the sixth paper sheet.

The impression cylinder 13 and blanket cylinder 12 further rotate. Immediately before the phase “1” of the impression cylinder 13 and the phase “B” of the blanket cylinder 12 come into contact with each other, the blanket cylinder 12 is separated from the impression cylinder 13 by the cylinder throw-on/throw-off device 39 to perform B-I throw-off. Therefore, the phase “1” of the impression cylinder 13 does not come into contact with the phase “B” of the blanket cylinder 12. At this time, the rod 168 of the pneumatic cylinder 167 moves forward, and the large-diameter portion 170a of the cam 170 is positioned at the operative position.

When the gripper device 36A of the impression cylinder 13 opposes the delivery grippers 24a of the delivery chains 24, the fourth paper sheet on which the two different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The fourth paper sheet is thus stacked on the pile board 9. When the gripping change is ended, the rod 168 of the pneumatic cylinder 167 moves backward, and the large-diameter portion 170a of the cam 170 is positioned at the retreat position.

The impression cylinder 13 and blanket cylinder 12 further rotate. Immediately before the phase “2” of the impression cylinder 13 and the phase “C” of the blanket cylinder 12 come into contact with each other, the blanket cylinder 12 is separated from the impression cylinder 13 by the cylinder throw-on/throw-off device 39 to perform B-I throw-off. Therefore, the phase “2” of the impression cylinder 13 does not come into contact with the phase “C” of the blanket cylinder 12.

The impression cylinder 13 and blanket cylinder 12 further rotate. Immediately before the phase “3” of the impression cylinder 13 comes into contact with the phase “D” of the blanket cylinder 12, the B-I throw-off is canceled by the cylinder throw-on/throw-off device 39 to bring the blanket cylinder 12 into contact with the impression cylinder 13. Thus, a blue pattern is printed on the sixth paper sheet.

The impression cylinder 13 and blanket cylinder 12 further rotate. Immediately before the phase “1” of the impression cylinder 13 comes into contact with the phase “A” of the blanket cylinder 12, impression throw-off is performed by the cylinder throw-on/throw-off device 39. As the result of the impression throw-off, the blanket cylinder 12 is separated from the impression cylinder 13 and plate cylinder 11. In the impression throw-off state, when the impression cylinder 13 and blanket cylinder 12 rotate by ⅔ revolution and 2/4 revolution, respectively, the rod 168 of the pneumatic cylinder 167 moves forward, and the large-diameter portion 170a of the cam 170 is positioned at the operative position.

When the gripper device 36B of the impression cylinder 13 opposes the delivery grippers 24a of the delivery chains 24, the fifth paper sheet on which the two different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The fifth paper sheet is thus stacked on the pile board 9. When the gripping change is ended, the rod 168 of the pneumatic cylinder 167 moves backward, and the large-diameter portion 170a of the cam 170 is positioned at the retreat position.

In this case, as the blanket cylinder 12 is thrown off, set-off on cylinder does not occur on the region of the phase “1” of the impression cylinder 13. The impression throw-off state is held until the printing is ended, so that the phase “3” of the impression cylinder 13 does not come into contact with the phase “C” of the blanket cylinder 12. In the impression throw-off state, when the impression cylinder 13 and blanket cylinder 12 rotate by one revolution and ¾ revolution, respectively, the rod 168 of the pneumatic cylinder 167 moves forward, and the large-diameter portion 170a of the cam 170 is positioned at the operative position.

When the gripper device 36C of the impression cylinder 13 opposes the delivery grippers 24a of the delivery chains 24, the sixth paper sheet on which the two different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The sixth paper sheet is thus stacked on the pile board 9, and the printing is ended. In the printing operation described above as well, the paper sheet is supplied to the impression cylinder 13 by the swing arm shaft gripper 10 each time the plate cylinder 11 rotates by one revolution.

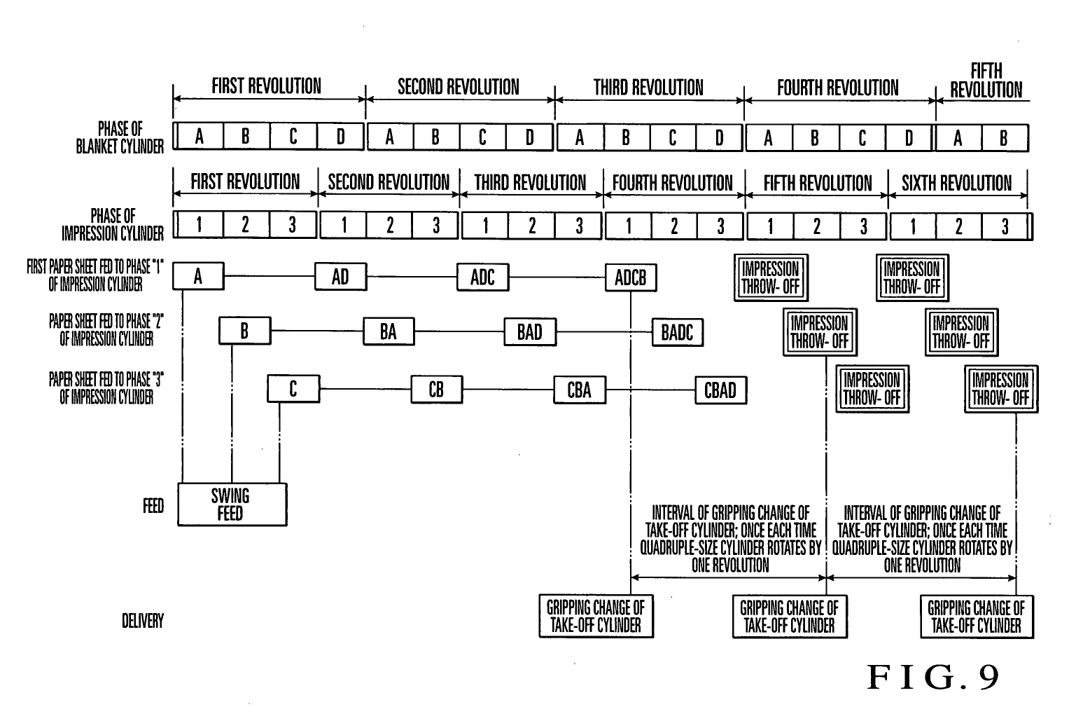

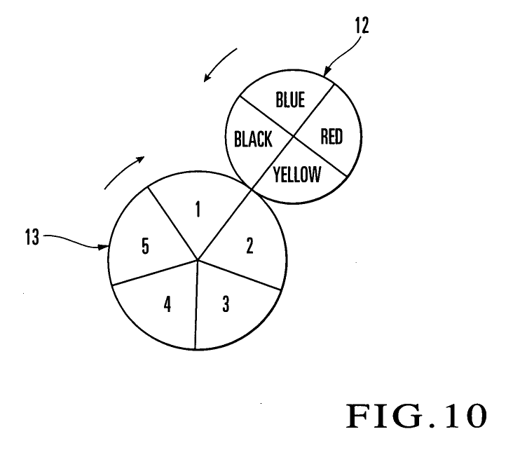

A case will be described with reference to FIG. 9 wherein four-color printing is to be performed on each of three paper sheets. In this printing operation, the printing order of the four colors is changed among the three paper sheets. B-I throw-off is not performed during printing.

Four plates 28A to 28D which are not plate-made yet are mounted on the plate cylinder 11 in accordance with the same method as that described above. The mounted plates 28A to 28D are plate-made by the plate making device 7. Subsequently, four different-color inks are supplied to the plate-made plates 28A to 28D by the four inking devices 15A to 15D. The four different-color inks supplied to the plates 28A to 28D are transferred as a black pattern, yellow pattern, red pattern, and blue pattern to the blankets 33A to 33D, with which the plates 28A to 28D respectively come into contact, of the blanket cylinder 12.

After the patterns are transferred, when a paper sheet 2 is fed onto the feeder board 3 by the feeder 4, it is positioned by the register device (not shown) and gripped by the grippers of the swing arm shaft gripper 10, and conveyed to the outer surface of the impression cylinder 13. At this time, the rod 68 of the pneumatic cylinder 67 which forms the gripper opening/closing device 60 moves forward. Thus, the large-diameter portion 70a of the cam 70 is positioned at the operative position, and the leading edge of the paper sheet 2 is gripping-changed to the gripper device 36A of the impression cylinder 13. In this state, when the impression cylinder 13 is rotated clockwise in FIG. 2 by ⅓ revolution, the gripper device 36A opposes the leading edge holding mechanism 31A of the blanket cylinder 12. Immediately before this, the blanket cylinder 12 is brought into contact with the impression cylinder 13 by the cylinder throw-on/throw-off device 39. When the impression cylinder 13 further pivots to bring the phase “A” of the blanket cylinder 12 and the phase “1” of the impression cylinder 13 into contact with each other, a black pattern is printed on the first paper sheet, as shown in FIG. 9.

Subsequently, when a paper sheet 2 is fed onto the feeder board 3 by the feeder 4, it is positioned by the register device (not shown) and gripped by the grippers of the swing arm shaft gripper 10. The paper sheet 2 gripped by the swing arm shaft gripper 10 is conveyed to the outer surface of the impression cylinder 13, and its leading edge is gripping-changed to the gripper device 36B of the impression cylinder 13. After that, when the impression cylinder 13 and blanket cylinder 12 rotate to bring the phase “2” of the impression cylinder 13 and the phase “B” of the blanket cylinder 12 into contact with each other, a yellow pattern is printed on the second paper sheet.

When the impression cylinder 13 and blanket cylinder 12 rotate by ⅓ revolution and ¼ revolution, respectively, a third paper sheet 2, which is fed onto the feeder board 3, positioned by the register device (not shown), and gripped by the grippers of the swing arm shaft gripper 10 is conveyed to the outer surface of the impression cylinder 13, and the leading end of the third paper sheet 2 is gripping-changed to the gripper device 36C of the impression cylinder 13. When the gripping change is ended, the rod 68 of the pneumatic cylinder 67 of the gripper opening/closing device 60 moves backward, and the large-diameter portion 70a of the cam 70 is positioned at the retreat position. In this state, when the impression cylinder 13 and blanket cylinder 12 rotate to bring the phase “3” of the impression cylinder 13 and the phase “C” of the blanket cylinder 12 into contact with each other, a red pattern is printed on the third paper sheet.

When the impression cylinder 13 and blanket cylinder 12 rotate by ⅓ revolution and ¼ revolution, respectively, the phase “1” of the impression cylinder 13 and the phase “D” of the blanket cylinder 12 come into contact with each other, and a blue pattern is printed on the first paper sheet. When the impression cylinder 13 and blanket cylinder 12 further rotate by ⅓ revolution and ¼ revolution, respectively, the phase “2” of the impression cylinder 13 and the phase “A” of the blanket cylinder 12 come into contact with each other, and a black pattern is printed on the second paper sheet.

When the impression cylinder 13 and blanket cylinder 12 further rotate by ⅓ revolution and ¼ revolution, respectively, the phase “3” of the impression cylinder 13 and the phase “B” of the blanket cylinder 12 come into contact with each other, and a yellow pattern is printed on the third paper sheet. When the impression cylinder 13 and blanket cylinder 12 further rotate by ⅓ revolution and ¼ revolution, respectively, the phase “1” of the impression cylinder 13 and the phase “C” of the blanket cylinder 12 come into contact with each other, and a red pattern is printed on the first paper sheet.

When the impression cylinder 13 and blanket cylinder 12 further rotate by ⅓ revolution and ¼ revolution, respectively, the phase “2” of the impression cylinder 13 and the phase “D” of the blanket cylinder 12 come into contact with each other, and a blue pattern is printed on the second paper sheet. When the impression cylinder 13 and blanket cylinder 12 further rotate by ⅓ revolution and ¼ revolution, respectively, the phase “3” of the impression cylinder 13 and the phase “A” of the blanket cylinder 12 come into contact with each other, and a black pattern is printed on the first paper sheet.

When the impression cylinder 13 and blanket cylinder 12 further rotate by ⅓ revolution and ¼ revolution, respectively, the phase “1” of the impression cylinder 13 and the phase “B” of the blanket cylinder 12 come into contact with each other, and a yellow pattern is printed on the first paper sheet. At this time, the rod 168 of the pneumatic cylinder 167 moves forward, and the large-diameter portion 170a of the cam 170 is positioned at the operative position.

When the gripper device 36A of the impression cylinder 13 opposes the delivery grippers 24a of the delivery chains 24, the first paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The first paper sheet is thus stacked on the pile board 9. When the gripping change is ended, the rod 168 of the pneumatic cylinder 167 moves backward, and the large-diameter portion 170a of the cam 170 is positioned at the retreat position.

When the impression cylinder 13 and blanket cylinder 12 further rotate by ⅓ revolution and ¼ revolution, respectively, the phase “2” of the impression cylinder 13 and the phase “C” of the blanket cylinder 12 come into contact with each other, and a red pattern is printed on the second paper sheet. Thus, four different-color patterns are printed on the second paper sheet. When the impression cylinder 13 and blanket cylinder 12 further rotate by ⅓ revolution and ¼ revolution, respectively, the phase “3” of the impression cylinder 13 and the phase “D” of the blanket cylinder 12 come into contact with each other, and a blue pattern is printed on the third paper sheet. Thus, four different-color patterns are printed on the third paper sheet.

At this time, the blanket cylinder 12 is separated from the impression cylinder 13 and plate cylinder 11 by the cylinder throw-on/throw-off device 39 to perform impression throw-off. When the impression cylinder 13 and blanket cylinder 12 further rotate by ⅓ revolution and ¼ revolution, respectively, the rod 168 of the pneumatic cylinder 167 moves forward, and the large-diameter portion 170a of the cam 170 is positioned at the operative position.

When the gripper device 36B of the impression cylinder 13 opposes the delivery grippers 24a of the delivery chains 24, the second paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The second paper sheet is thus stacked on the pile board 9. When the gripping change is ended, the rod 168 of the pneumatic cylinder 167 moves backward, and the large-diameter portion 170a of the cam 170 is positioned at the retreat position.

When the impression cylinder 13 and blanket cylinder 12 further rotate by 3/3 revolution and ¾ revolution, respectively, the rod 168 of the pneumatic cylinder 167 moves forward, and the large-diameter portion 170a of the cam 170 is positioned at the operative position.

When the gripper device 36C of the impression cylinder 13 opposes the delivery grippers 24a of the delivery chains 24, the third paper sheet on which the four different-color patterns are printed is gripping-changed, and the leading edge of the paper sheet is gripped by the delivery grippers 24a. The paper sheet gripped by the delivery grippers 24a is conveyed as the delivery chains 24 travel, and delivered as it is released above the pile board 9 of the delivery unit 6. The third paper sheet is thus stacked on the pile board 9, and the printing is ended.

In the printing operation described above, the paper sheets are supplied to the impression cylinder 13 by the swing arm shaft gripper 10 only while the impression cylinder 13 rotates the first revolution. The paper sheet is supplied to the impression cylinder 13 by the swing arm shaft gripper 10 each time the impression cylinder 13 rotates by ⅓ revolution. When four to six paper sheets are to be supplied to the impression cylinder 13 by the swing arm shaft gripper 10, they are supplied while the impression cylinder 13 rotates the seventh revolution. When four-color printing is to be performed on each of the four to six paper sheets, the printing operation is performed in the same manner as the operation that takes place while the impression cylinder 13 rotates the first to sixth revolutions.

FIG. 10 is a model view showing an impression cylinder for a sheet-fed offset rotary printing press according to the second embodiment of the present invention.

The second embodiment is different from the first embodiment in that an impression cylinder 13 has a quintuple size, that five gripper devices are provided to the impression cylinder 13, and that five printing surfaces are formed on the outer surface of the impression cylinder 13. In this structure, the blanket cylinder 12 is thrown on onto and off from the impression cylinder 13 by a cylinder throw-on/throw-off device 39 at appropriate timings in the same manner as with the impression cylinder having three printing surfaces described above. Thus, multicolor printing can be performed on five paper sheets gripped by the five gripper devices of the impression cylinder 13.

In the embodiments described above, the printing cylinder includes the plate cylinder 11 and the blanket cylinder 12 which is in contact with the plate cylinder 11, and the blanket cylinder 12 is brought into contact with the impression cylinder 13. Alternatively, the plate cylinder 11 may be brought into direct contact with the impression cylinder 13 without using any blanket cylinder 12. Only cases wherein the impression cylinder 13 has three printing surfaces and a case wherein the impression cylinder 13 has five printing surfaces have been described. It suffices if the impression cylinder 13 has an odd number of printing surfaces with respect to the four printing surfaces of the blanket cylinder 12, so that the printing surfaces of the impression cylinder 13 will not come into contact with the same corresponding printing surfaces of the blanket cylinder 12.

The impression cylinder 13 is selectively thrown off from the blanket cylinder 12, so that another ink will not be printed on the printing surfaces of the impression cylinder 13. If the impression cylinder has only one printing surface, printing can be performed in the impression throw-on state. Depending on the arrangement of the four printing surfaces of the blanket cylinder, the impression cylinder can be thrown off selectively. Although printing is performed in the above embodiments in the order of black→blue→red→yellow, it can be performed in any printing order. As a sheet, a vinyl chloride sheet or film, or the like can be used.

As has been described above, according to the present invention, since color misregistration does not occur when multicolor printing is performed, the printing quality is improved. Since no adjustment is required to prevent color misregistration, the productivity is improved. As one plate making device suffices, the manufacturing cost of the printing press can be decreased.

1. A sheet-fed offset rotary printing press comprising:
one plate cylinder having an outer surface on which at least one plate member is mounted;
one blanket cylinder which opposes said plate cylinder and has an outer surface on which at least one blanket is mounted, said blanket cylinder having the same size as that of said plate cylinder;
one impression cylinder having at least one sheet holding means for holding a sheet;
one plate making device which can inscribe four printing patterns on four regions of said plate member while said plate member is mounted on said plate cylinder;
four inking devices which individually supply inks to the four printing patterns of said plate member mounted on said plate cylinder through four form rollers;
four roller throw-on/throw-off devices which throw on one of said four form rollers onto a corresponding one of the four printing patterns of said plate member mounted on said plate cylinder and throw off the remaining ones of said form rollers from the remaining ones of the printing patterns; and
a cylinder throw-on/throw-off device which throws on said blanket cylinder immediately before said blanket cylinder, to which the inks have been supplied from said four inking devices through said plate cylinder, and said sheet held by said sheet holding means oppose each other, and throws off said blanket cylinder immediately before said blanket cylinder and said impression cylinder, while said sheet holding means does not hold a sheet, oppose each other.

2. A press according to claim 1, wherein
said impression cylinder has a plurality of sheet holding means, and
said cylinder throw-on/throw-off device throws off said blanket cylinder immediately before said sheet holding means that do not hold sheets oppose said blanket cylinder.

3. A press according to claim 1, further comprising a sheet supply device which supplies a sheet to said impression cylinder each time said plate cylinder rotates by one revolution.

4. A press according to claim 1, wherein said impression cylinder has an odd number of sheet holding means.

5. A press according to claim 1, wherein
four plate members are mounted on the outer surface of said plate cylinder equidistantly in a circumferential direction,
four blankets are mounted on the outer surface of said blanket cylinder equidistantly in a circumferential direction,
said impression cylinder has three sheet holding means equidistantly in a circumferential direction, and
a ratio of sizes of said plate cylinder, blanket cylinder, and impression cylinder is set to 4:4:3.

6. A press according to claim 1, further comprising a gripper opening/closing device which has a cam for opening/closing said sheet holding means,
wherein when the sheet is positioned at a gripping change position where the sheet is to be supplied by a feeder, gripping change operation of said sheet holding means is performed by said cam, and
the gripping change operation of said sheet holding means at the gripping change position is performed each time said plate cylinder rotates by one revolution.

7. A press according to claim 1, further comprising a gripper opening/closing device which has a cam (70) for opening/closing said sheet holding means,
wherein when a printed sheet is positioned at a gripping change position where the sheet is to be delivered to a delivery unit, gripping change operation of said sheet holding means is performed by said cam, and when a non-printed sheet is positioned at the gripping change position, gripping change operation of said sheet holding means by said cam is not performed, and
the gripping change operation of said sheet holding means at the gripping change position is performed each time said plate cylinder rotates by one revolution.

8. A press according to claim 7, wherein
said delivery unit has a delivery chain having delivery grippers which perform gripping change of a sheet with respect to said sheet holding means at a constant interval, and
a distance between adjacent ones of said delivery grippers is set equal to a length of a circumference of said plate cylinder.
